(19) United States
(12) Patent Application Publication
(10) Pub. No.: US 2014/0135196 A1
(43) Pub. Date: May 15, 2014

(54) APPARATUS AND METHOD FOR MANUFACTURE OF A SECONDARY PACKAGE

(71) Applicants: Michael Berglin, Malmo (SE); Nils-Olof Jönsson, Veberod (SE)

(72) Inventors: Michael Berglin, Malmo (SE); Nils-Olof Jönsson, Veberod (SE)

(73) Assignee: TETRA LAVAL HOLDINGS & FINANCE S.A., Pully (CH)

(21) Appl. No.: 14/126,575

(22) PCT Filed: Aug. 17, 2012
(86) PCT No.: PCT/SE2012/050882

§ 371 Date: Dec. 16, 2013

(30) Foreign Application Priority Data
Aug. 19, 2011 (SE) 1100601-2

(51) Int. Cl. B31B 3/00

(52) U.S. Cl. CPC B31B 3/00
USPC 493/416

(57) ABSTRACT

A method for producing a lid for a secondary package, the secondary package intended to encase primary packages, wherein the method comprises: folding the lid from a cardboard blank, comprising: side areas along a length of the blank, and the method comprises: picking the cardboard blank from a magazine with a picking unit; moving the picking unit, holding the cardboard blank to a position adjacent to a folding unit; transferring the cardboard blank from the picking unit to the folding unit, whereby the folding unit acts as an anvil and the picking unit acts as a stamp; thereby folding the side areas of the cardboard blank to form long lid sides, and forming short edges of the cardboard blank to short lid sides by folding them and holding them together, to form the lid for the secondary package. The invention also relates to an apparatus for performing the method.

### TECHNICAL FIELD

This invention pertains in general to the field of packaging. More particularly the invention relates to secondary packages, used to group and ship articles already packaged in primary packages.

### BACKGROUND

Secondary packaging apparatuses, e.g. a cardboard packer, for packaging primary packages, e.g. cardboard-based milk packages, in a secondary package comprising a tray and a lid, are known in the art.

Document U.S. Pat. No. 4,571,916 discloses a machine for segregating and packaging a plurality of articles in a wrap-around carton. The articles to be packaged are arranged on a cardboard blank. The tuck flaps of the cardboard blank and the side panels of the cardboard blank are elevated in upright positions around the selected articles to form a tray. The inner top panel is folded down onto the selected articles, thereby forming a lid, and retained there while adhesive is applied to the top panels, thereby forming the secondary package ready for shipment.

However, since the carton is a wrap-around carton made from a single cardboard blank, when the articles shipped are to be unpacked, the whole secondary package must be removed to display the articles in a presentable manner, since the tray is attached to the lid. Alternatively, the lid may be opened at the points of the adhesive, and the other side of the lid may be cut in order to separate the lid of the carton from the bottom of the carton, thereby displaying the articles.

This is disadvantageous, since it instigates an extra workload on personnel performing the unpacking.

Thus, there is a need for a new secondary package, providing easier access to its content.

Also, an apparatus for providing such secondary package would be advantageous and in particular an apparatus allowing for increased flexibility, quality, user friendliness and/or cost-effectiveness would be advantageous.

### SUMMARY

Accordingly, the present invention preferably seeks to alleviate or eliminate one or more of the above-identified deficiencies in the art and disadvantages singly or in any combination and solves at least the above mentioned problems by providing an apparatus and a method according to the appended patent claims. In general, the invention relates to improved folding of a lid of the type normally used for a tray-and-lid type of secondary package.

The lid blank is folded using the stamp/pad principle. When folding the lid cardboard, a picking unit is used as a stamp, and a folding unit is used as a pad. Using this technique, the folding is ensured and is not sensitive to the quality of the cardboard material, e.g. cardboard material that is very stiff.

According to aspects of the invention, a method and an apparatus are disclosed, whereby a lid blank is folded using the stamp/pad principle. When folding the lid cardboard blank, a picking unit is used as a stamp, and a folding unit is used as a pad.

According to a first aspect of the invention, a method for producing a lid for a secondary package is provided. Said method comprises folding the lid from a cardboard blank, comprising side areas along a length of the blank.

The method may comprise the steps of picking a cardboard blank from a magazine with a picking unit; moving the picking unit, holding the cardboard blank to a position adjacent to a folding unit; transferring the cardboard blank from the picking unit to the folding unit, whereby the folding unit acts as an anvil and the picking unit acts as a stamp; thereby folding the side areas of the cardboard blank to form long lid sides, and forming short edges of the cardboard blank to short lid sides by folding them and holding them together, to form the lid for the secondary package.

An advantage with this is that the folding is ensured and not sensitive to the quality of the cardboard blank material, e.g. cardboard blank material that is very stiff.

The step of forming the short edges of the cardboard blank may comprise the steps of folding side flaps towards each other, so that they are substantially perpendicular, at a 90° angle, in relation to the long side edges, to form short lid sides; applying an adhesive to the surface of the side flaps facing away from the primary packages; and folding a side cover over the side flaps.

The step of forming the short lid sides of the cardboard blank may comprise the step of folding the side areas of the cardboard blank to form long lid sides, in turn comprising a first, a second and a third folding, a first folding in which the long lid sides are folded less than 90 degrees, a second folding in which said long sides are folded to a 90 degree angle relative to a main area of the cardboard blank, a third folding of the side flaps, to form short sides of the lid, and with synchronization of the second and third folding through a synchronization means using the movement of the second folding as the driving force.

According to a second aspect of the invention, an apparatus for producing a lid for a secondary package is disclosed, said secondary package encasing primary packages, said apparatus comprising a lid folder, comprising a folding unit and a picking unit, wherein both the folding unit and the picking unit comprises holding means, positioned in relation to the folding unit so that, in use, a cardboard blank is folded between the picking unit and the folding unit, with the folding unit acting as an anvil and the picking unit acting as a stamp, when the cardboard blank is transferred from the holding means of the picking unit to the holding means of the folding unit.

The folding unit may comprise folding brackets facing the picking unit, when the picking unit is in the position adjacent the folding unit.

The folding bracket of the folding unit acts on the lid's long side edges, close to weakening lines of the cardboard blank. The distance between a holding means of the picking unit, acting on the opposite side of the lid compared to the folding bracket of the folding unit, and said weakening line, as measured perpendicular to said weakening line, may be below 20 mm.

This is advantageous, since a short distance between a holding means of the picking unit and the respective folding bracket located closest to the holding means, such as below 20 mm, may result in a favorable distribution of folding force, acting on the cardboard blank on either side of the weakening line, which causes the cardboard blank to be correctly folded.

Folding assemblies, comprising folding means for folding the cardboard blank, may be mounted on a folding carrier.

This is advantageous, since the distance, as measured in a first direction, between the folding assemblies may be varied in order to adapt the folding unit for blanks of different sizes.

The folding carrier may comprise holding means of the folding unit.

This is advantageous, since the proximity of the suction cup to the folding assembly will provide a firm hold of the cardboard blank close to the point of folding, i.e. the folding assembly.

The folding carriers may be mounted to a track.

This is advantageous, since the distance between the folding assemblies, as measured in a second direction perpendicular to the first direction, may be varied. In FIG. 6, the two top folding assemblies are shown mounted in two different positions, as an example. During normal operation, the folding assemblies are mounted symmetrically.

The folding unit, may comprise a vertical transport arm, attached to a number of hanging rods, which are aligned substantially parallel to the base level and substantially perpendicular to the central axis of the vertical transport arm, and wherein the hanging rods penetrate two side plates, which side plates are slidable along the length of the hanging rods, and which side plates are releasably fixated in an optional position on the hanging rods.

This is advantageous, since the width of the folding unit may then be adjusted by moving the side plates in relation to each other.

The present invention has the advantage over the prior art that it enables improved folding of a lid from a cardboard blank.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which

FIGS. 1 to 3 are flowcharts of methods according to embodiments;

FIGS. 4A and 4B are illustrations showing a lid folder according to an embodiment, where FIG. 4A is a perspective view and FIG. 4B is a side view;

FIGS. 5A, 5B and 6 are illustrations showing a folding unit according to an embodiment, where FIG. 5A is a view from one side, FIG. 5B is a view from another side, and FIG. 6 is a view from below;

FIGS. 7A, 7B and 7C are illustrations showing a tray folder, where FIG. 7A is a perspective view, FIG. 7B is a view from one side and FIG. 7C is a view from another side;

FIG. 8A is an illustration of a cardboard blank for use with the invention,

FIG. 8B is an illustration of a second cardboard blank, for forming a tray; and

FIG. 9 is an illustration showing folding of a secondary package with a lid, according to an embodiment of the invention.

### DESCRIPTION OF EMBODIMENTS

Several embodiments of the present invention will be described in more detail below with reference to the accompanying drawings in order for those skilled in the art to be able to carry out the invention. The invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments do not limit the invention, but the invention is only limited by the appended patent claims. Furthermore, the terminology used in the detailed description of the particular embodiments illustrated in the accompanying drawings is not intended to be limiting of the invention.

The following description focuses on an embodiment of the present invention applicable to a secondary package and in particular to a cardboard secondary package with a separate tray and lid. However, it will be appreciated that the invention is not limited to this application but may be applied to many other packages as will be appreciated by a person skilled in the art.

The apparatus described herewith, may suitably be used in a larger packaging system, such as a system for packaging fluid products for subsequent shipping, which will be obvious to a person skilled in the art.

A secondary package is formed in the following way. A tray blank is folded, using a folding mechanism, along crease lines such that a tray, comprising a tray bottom and tray side walls, is formed. Then, primary packages are loaded onto the tray bottom during which operation flaps are holding the tray side walls in an erected position. After loading, the flaps release the tray side walls which are then striving outwards due to the stiffness of the cardboard. A lid comprising a lid top and lid side walls are placed over the primary packages, inside the release tray flaps. The lid is formed by folding a lid blank, using a folding mechanism, along crease lines such that a lid, comprising a lid top and lid side walls, is formed.

Finally, glue is applied to the outside of the lid side walls before the tray side walls are forced back, by the flaps, into the erected position, When the tray side walls are in the upright position, the lid side walls are stuck between the primary packages and the tray side walls. Thus, when the glue dries, the lid and the tray adhere to each other so as to form a frame. The tray side walls and the lid side walls are then glued so that they close the secondary package. Thereby, a tray with four side walls holding the lid in place between the primary packages and the tray side walls is formed. This will be described further below.

Lid Folder

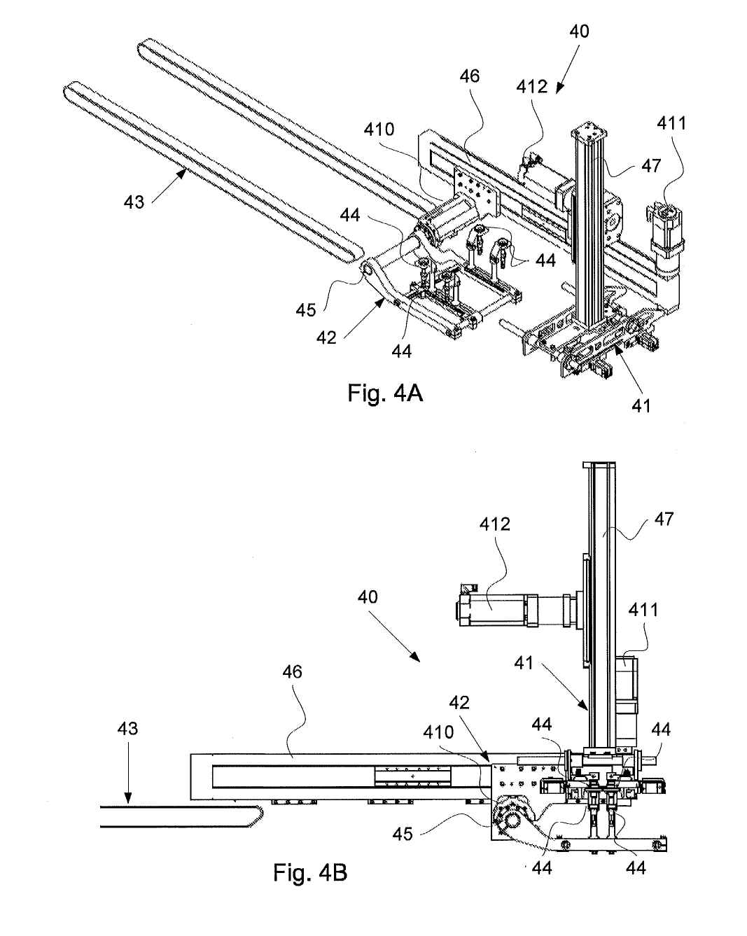

In an embodiment of the invention according to FIG. 4, a lid folder 40 is disclosed. FIG. 4A is a perspective view and FIG. 4B is a side view. The lid folder comprises a folding unit 41 and a picking unit 42. Both the folding unit 41 and the picking unit comprises holding means for holding a lid blank (not shown) so that it may be moved from a magazine 43 and processed by the lid folder 40. In this embodiment, the holding means are suction cups 44. The picking unit 42 picks a lid blank (not shown) from the magazine 43 by rotating around an axis 45, from the position displayed in FIG. 4 to a position (not shown) where the suction cups 44 of the picking unit 42 faces the cardboard blanks positioned in the magazine 43. The rotation is facilitated by a first electric motor 410, in a way obvious to a person skilled in the art. Throughout the description, it will also be obvious to a person skilled in the art that instead of an electric motor, other suitable means may be used, such as pistons, pneumatic and/or hydraulic, etc. When in contact with a cardboard blank, the suction cups 44 apply an under pressure, thus holding the cardboard blank attached to the picking unit 42 so that the cardboard blank is picked from the magazine 43 when the picking unit 42 rotates back around the axis 45, to its starting position.

The picking unit 42 is movably mounted on a horizontal transport arm 46, so that it can move on the transport arm 46 between a position adjacent to the magazine 43 (as shown in FIG. 4A) and a position adjacent to the folding unit 41 (as shown in FIG. 4B), thereby moving cardboard blanks between the magazine 43 and the folding unit 41. The movement is accomplished by means of a second electric motor 411, in a way obvious to a person skilled in the art.

The folding unit 41 and the picking unit 42 are positioned in a way so that in use, when the picking unit 42 is adjacent to the folding unit 41 (as shown in FIG. 4B), the cardboard blank can be transferred from the picking unit 42, which is holding the cardboard blank by applying under pressure through the suction cups 44, to the folding unit 41 by first applying an under pressure to the suction cups 44 of the folding unit 41 and then releasing the under pressure of the suction cups 44 of the picking unit 42. Thus, the cardboard blank is held attached to the folding unit 41 while being released from the picking unit 42.

After delivering a first cardboard blank (not shown), as disclosed above, the picking unit can be moved along the horizontal transport arm 46 to a position adjacent to the magazine 43 (as shown in FIG. 4A), rotate around the axis 45 and in a repetitive fashion pick up a second, third, fourth etc. cardboard blank (not shown) as described above, for subsequent transportation to the folding unit 41.

The folding unit 41 is mounted on a vertical transport arm 47, so that it can move from a position adjacent to the picking unit 42 (as shown in FIG. 4B), to a folding position, and subsequently a position adjacent to the primary packages where the lid is to be applied, the application position (not shown), thereby first folding the cardboard blank to form a lid (not shown) and secondly applying the lid to primary packages. The movement is accomplished by means of a third electric motor 412, in a way obvious to a person skilled in the art. In this embodiment, the direction of movement between the first and the second position of the folding unit 41 is perpendicular to the direction of movement of the picking unit 42, when the picking unit 42 is moving between the position adjacent to the magazine 43 (as shown in FIG. 4A) and the position adjacent to the folding unit 41 (as shown in FIG. 4B). The transfer of the cardboard blank from the picking unit 42 to the folding unit 41 hence takes place when the folding unit 41 is lowered onto the picking unit 42, using the third electric motor 412. After the transfer of the cardboard blank, the picking unit 42 and the folding unit 41 are separated, by lifting the folding unit 41, such that the picking unit 42 can retrieve another cardboard blank from the magazine 43.

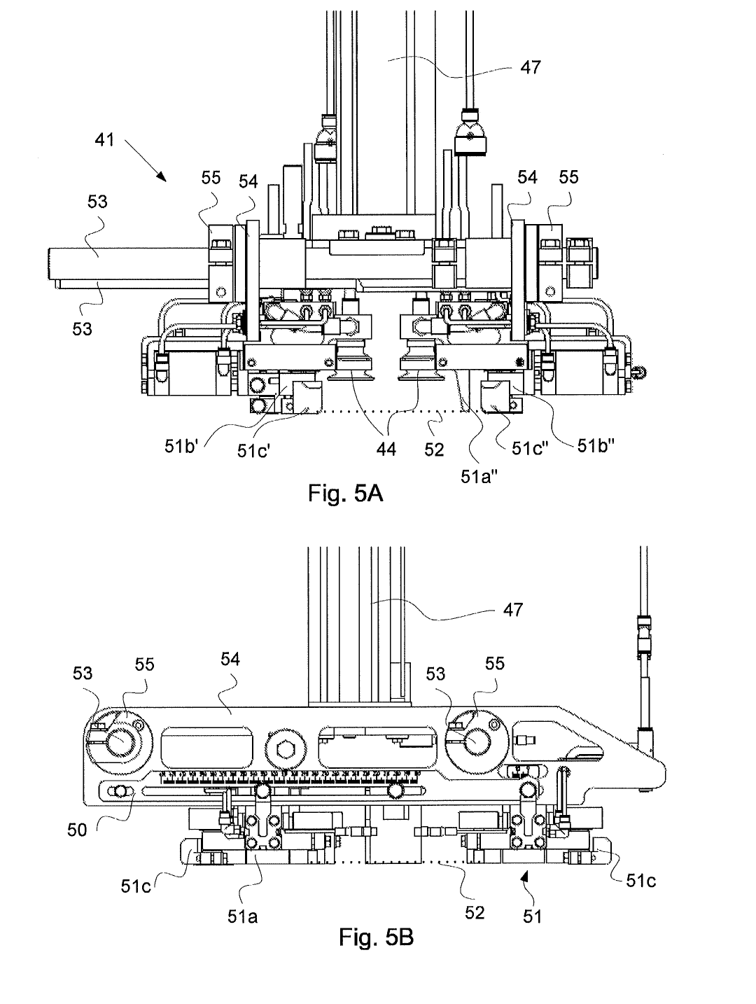

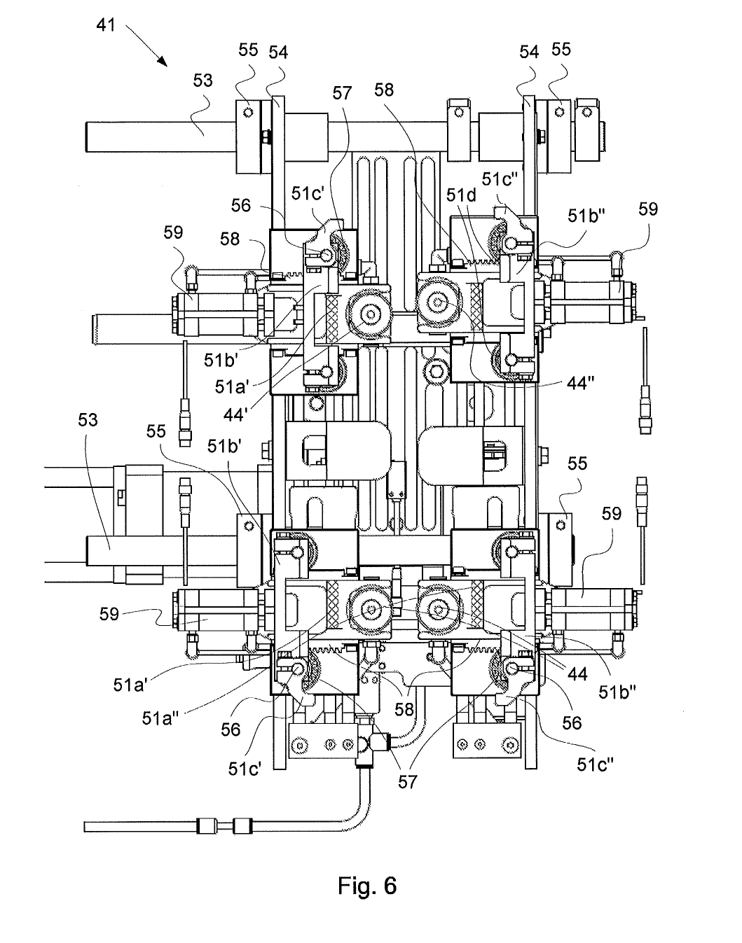

The folding unit 41, according to this embodiment, will now be described in more detail with reference to FIGS. 5 and 6.

A front view of the folding unit 41 is shown in FIG. 5A. As already explained above, the folding unit 41 comprises holding means for holding a lid blank. In this embodiment, the holding means are suction cups 44. Furthermore, the folding unit 41 is mounted on a vertical transport arm 47, so that it can move from a position adjacent to the picking unit 42 (as shown in FIG. 4B), to a folding position, and subsequently to a position adjacent to the primary packages where the lid is to be applied, the application position (not shown), thereby firstly folding the cardboard blank to form a lid (not shown) and secondly applying the lid to primary packages.

The folding unit 41 also comprises folding assemblies 51, which are aligned at a base level 52 (dotted line), which is an imaginary plane drawn up by the exterior surfaces of the folding assemblies 51 facing the picking unit 42, when the picking unit is in the position adjacent the folding unit 41. The folding assemblies 51 comprise a folding bracket 51a, a folding slide 51b and a folding finger 51c.

In the shown embodiment, the folding bracket 51a is (adjustably) fixed to the folding unit, the folding slide 51b can slide between an inoperative position (retracted) and an operative position (extended), and the folding finger 51c is pivotably mounted to the folding slide 51b, and moves between an open and a closed position when the folding slide 5 lb moves between the inoperative and the operative position. The folding bracket 51a is in the shown embodiment angled slightly outward from the center of the folding unit 51, as can be seen in FIG. 5A.

The suction cups 44 of the folding unit 41 are positioned at a perpendicular distance from the base level 52, which creates a folding space. The folding space can be seen in FIG. 5A as the rectangular shaped space between the suction cups 44 and the base level 52 (dotted line).

In use, a cardboard blank is folded in the folding space, when it is transferred from the picking unit 42 to the folding unit 41. The folding is caused by the pushing force of the picking unit 42, in the shown embodiment by the suction cups 44, acting inside the weakening lines of the cardboard blank, and the pushing force of the folding bracket 51a acting on the lid long sides.

Thus, the lid folder is using a stamp/pad principle. When folding the cardboard blank, the picking unit 42 is stamping the cardboard blank towards the folding unit 41, which is used as a pad or anvil, especially the folding bracket 51a. Since the cardboard blank is pressed into the folding space, a folding is obtained, with the picking unit 42 acting as a stamp. The outwardly angled folding bracket 51a leaves the lid's long sides angled slightly outward, in order to more easily allow placing the prefolded lid on top of packages to be packaged. The folding slides 51b are arranged to push the lid's long sides to a closed position against the packages, at a later stage, using flat sections 51d.

In the shown embodiment, each folding slide 51b comprises two flat sections 51d, arranged to be moved on either side of a respective folding bracket 51a. The flat sections 51d are perpendicular to the base level 52.

An advantage with this is that folding may be ensured in a way, not sensitive to the quality of the card board material, such as with a cardboard material that is very stiff.

The distance between a particular holding means of the picking unit 42 and the respective folding bracket 51a located closest to the holding means may be relatively short, such as below 20 mm and preferably between 10 mm and 20 mm, such as approx 14 mm.

This is advantageous, since a relatively short distance between a particular holding means of the picking unit and the respective folding bracket 51a located closest to the holding means may result in a favorable distribution of folding force, acting on the cardboard blank, which causes the long side areas of the cardboard blank to be correctly folded along the crease line.

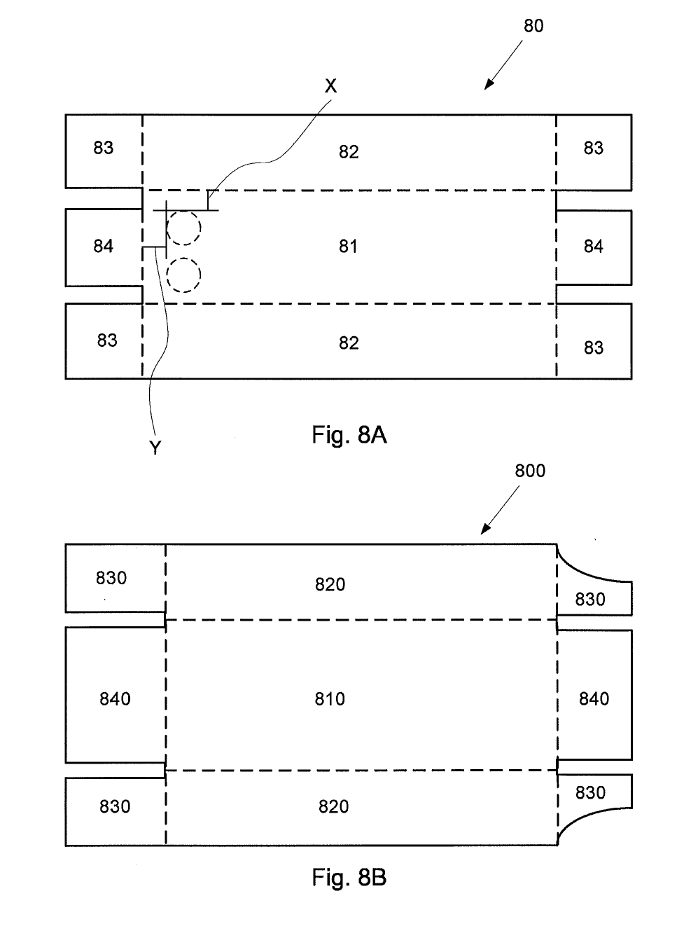

This is further illustrated in FIG. 8A. The distance X, as seen in FIG. 8A, is the distance between the suction cup 44 of the picking unit 42 (dotted circle) and the weakening line of the lid's long side 82. This distance may be about 14 mm. The distance Y is the distance between the same suction cup and the weakening line of the lid's short side 84. This distance Y may be about 13 mm. By being this close to the weakening lines, a pushing force is achieved close to said line in order to create a distinct folding action. A smaller distance could lead to problems if there are inaccuracies in the location of the weakening lines. The distances X, Y may in one embodiment be about 10-20 mm for good, consistent performance, as mentioned above.

Since the lid folder is adapted to fold boxes, i.e. objects with certain symmetry, the construction of the folding unit 41 also shows a certain amount of symmetry. The vertical transport arm 47 is attached to a number of hanging rods 53, which are aligned substantially parallel to the base level 52 and substantially perpendicular to the central axis of the vertical transport arm 47. The hanging rods 53 penetrate two side plates 54, which side plates 54 may slide along the length of the hanging rods 53. The side plates 54 may be releasably fixated in an optional position on the hanging rods 54 by plate securing means 55, in this embodiment a clamp, secured to the side plate 54 and traversed by the hanging rod 53, which clamp may be released or tightened with a screw. On each of the side plates 54, folding assemblies 51 are releasably fixated in certain positions.

This is advantageous, since the distance between the folding assemblies 51 may be varied.

Each folding assembly 51 is mounted on a folding carrier, which according to this embodiment also comprises suction cup 44.

This is advantageous, since the proximity of the suction cup 44 to the folding assemblies 51 will provide a firm hold of the cardboard blank (not shown) close to the point of folding, i.e. the folding bracket 51a.

At least one of the folding carriers is mounted on a track 50 and may slide along this track 50 along the length of the side plate 54, making it adjustable, see FIG. 5B.

This is advantageous, since the distance between the folding assemblies 51 may be varied.

FIG. 6 is a view of the folding unit 41 from below, i.e. from the side which in use is adjacent to the picking unit 42. Since the distance between folding units may be adjusted partly by adjusting the positions of the side plates 54 along the length of the hanging rods 53, and partly by adjusting the position of the folding carrier in each track 50 of the side plates 54, the size of the folding space, which is an imaginary rectangle limited by one folding unit in each corner, can be varied. Thus, the folding unit 41 may be adjusted to accommodate several types of cardboard blanks, and provide folding into different sized lids.

In use, the folding unit 41 provides folding of cardboard blanks in two steps. The first step, folding of the long side of the lid, is obtained by the stamp/pad principle as described above, i.e. when the cardboard blank is transferred from the picking unit 42 to the folding unit 41. This folding of the long side takes place between the folding brackets 51a, mounted on the same side plate 54. The second step, folding of the short side of the lid, is obtained between the folding fingers 51c′ and 51c″ mounted opposite each other on different side plates 54.

Each folding finger 51c is movably mounted on a pivot 56, which has a cogwheel 57. A cogged rack 58, mounted to the folding unit 41, interacts with the cogwheel 57, when the folding slide 51b is regulated by an air pressure unit 59 in a way known to a person skilled in the art. As the folding slide 51b is moved to the operative position, pushing the lid long sides 82 to a substantially 90 degree angle in relation to the main area 81 (see FIG. 8A), the rack 58 will turn the cogwheel 57 and cause the flap folding finger 51c to pivot around the pivot axis 56 from an open position (as shown in FIG. 6) to a closed position, moved 90° towards the center of the folding space (not shown).

In use, when the folding fingers 51c move from the open position to the closed position, the short edges of the lid are formed, which will be explained further below.

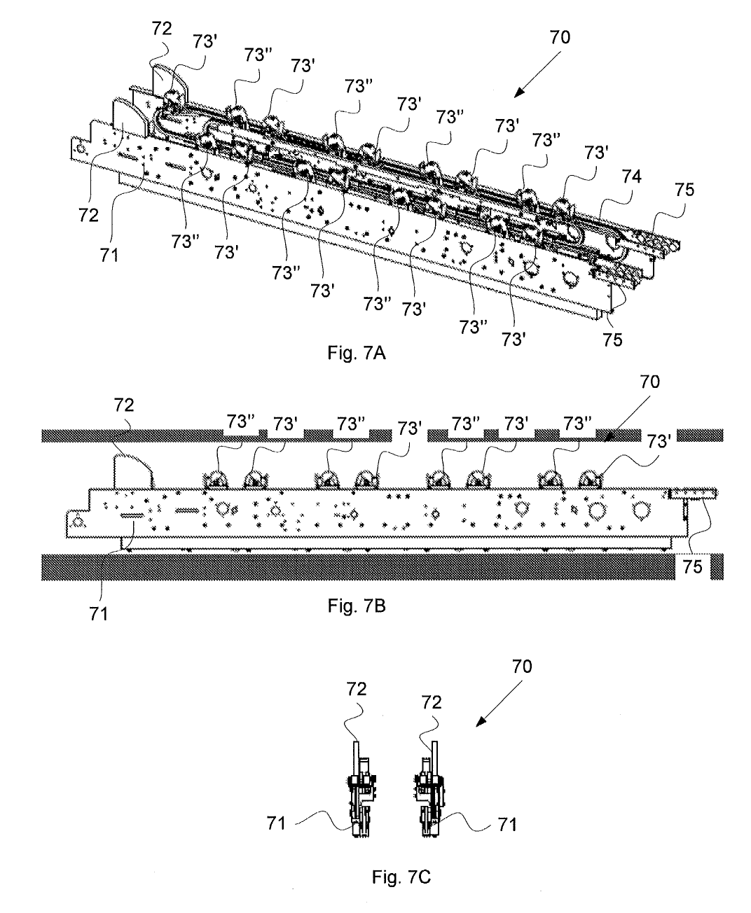

FIGS. 7A, 7B and 7C show a tray folder for folding a tray to be used with the lid for forming a secondary package. The tray folder 70 comprises two support rails 71 each having a tray loading support 72. Several operation flaps 73 are arranged on a transport track 74, being mounted on the support rail 71. The trays are formed between the operation flaps 73 in a per se known way, which is not part of the invention.

The cardboard blank used to fold a secondary carton may be any kind of cardboard material, as will be appreciated by the person skilled in the art. The design of the cardboard blank may be any kind of design, suitable for folding with a long side and a short side, as appreciated by the person skilled in the art.

In an embodiment according to FIG. 8, a cardboard blank design is provided. The cardboard blank is planar with two sides, called the long sides, having long ends, extending along a first axis in the plane and two sides, called the short sides, having short ends, extending along a second axis in the plane, which second axis is perpendicular to the first axis. FIG. 8A is a top view of a cardboard blank 80 design for a lid and FIG. 8B is a top view of a second cardboard blank 800 design for a tray. Dotted lines are provided to mark the lines along which folding takes place.

In general, both the lid and the tray has a main area 81, 810, which will form the top 81 or bottom 810, respectively, of the finished secondary package. Each cardboard blank 80, 800 also have long side areas 82, 820, on each side of the main area 81, 810. At each of opposite short ends of the cardboard blank 80, 800, two cuts are made forming two side flaps 83, 830 and a side cover 84, 840, separated by the cuts.

As will be understood by a person skilled in the art, even though the above is described in relation to long and short edges, respectively, the cardboard blank design is also applicable to a square geometric shape, i.e. where all edges are equally long.

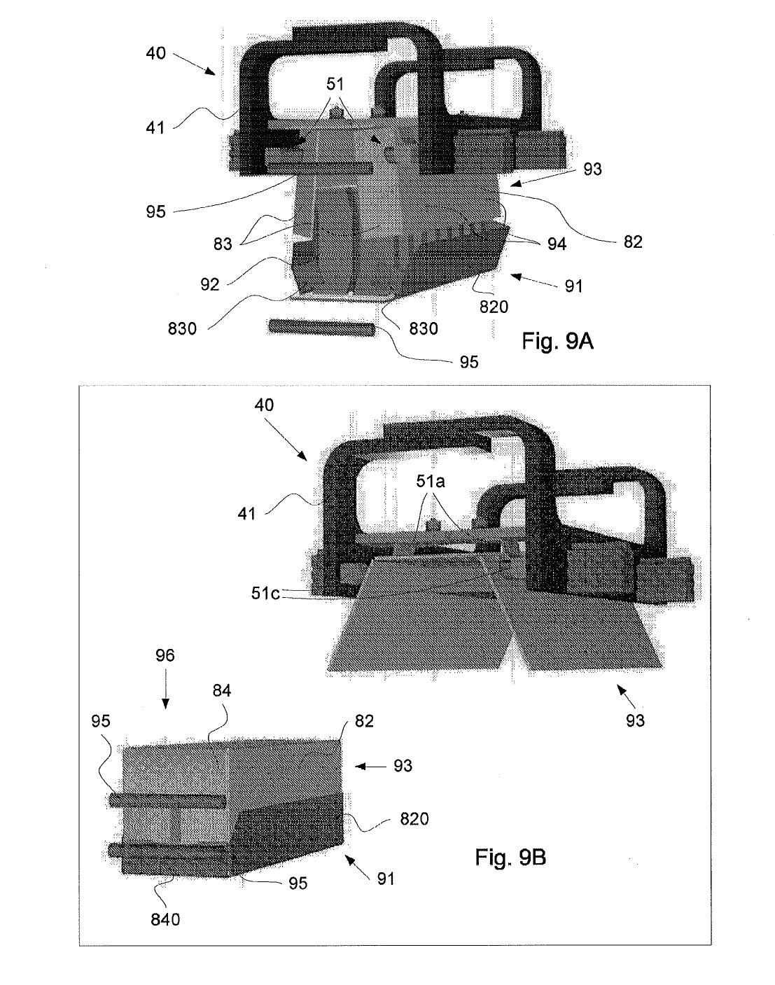

FIG. 9A shows a step in the process of folding a tray 91, from the second cardboard blank, the tray blank, for holding primary packages 92. The tray 91 is adapted to form a pair with a lid 93, folded from the cardboard blank 80 for the lid, the lid blank, and adapted to be paired with a tray 91 to form a secondary package for primary packages 92. This is accomplished by means of the folding unit 40 and the tray folder 70.

### Lid Folding

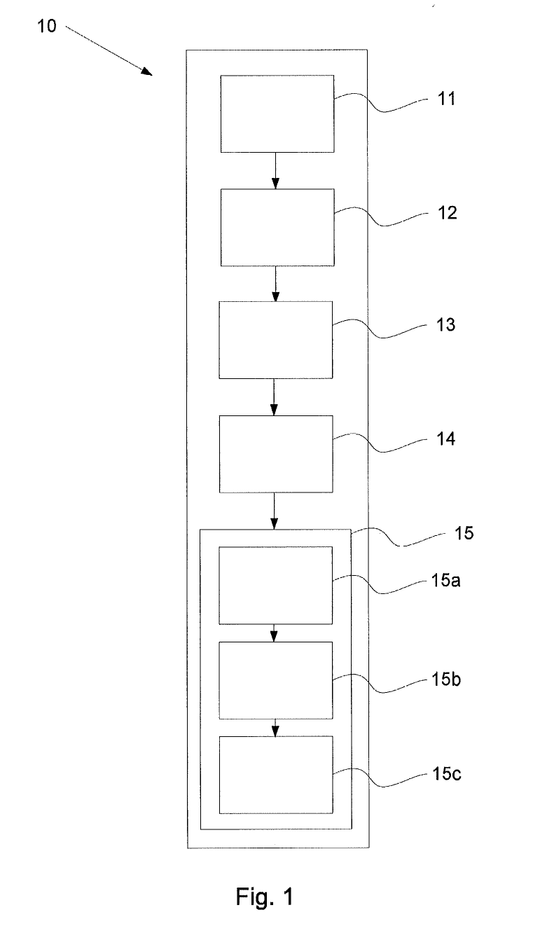

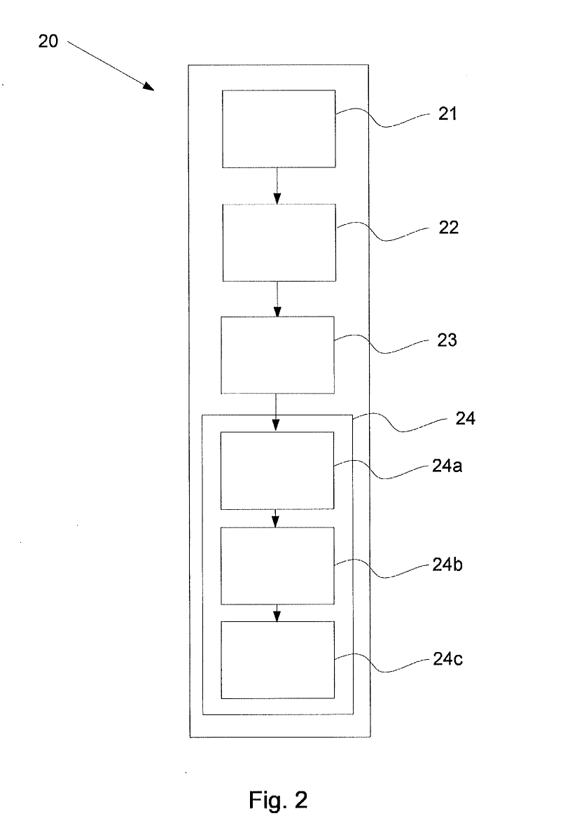

In an embodiment, lid folding is performed according to a method, which method steps are provided in the flow chart according to FIG. 1.

Thus, FIG. 1 provides a method 10 for producing a lid for a secondary package. Said secondary package generally comprises a separate lid and tray, intended to encase primary packages. The method 10 comprises folding the lid from a cardboard blank 80, comprising side areas 82 along a length of the blank. This is done in a number of steps, where the first step is picking 11 the cardboard blank 80 from a magazine 43 with a picking unit 42. Next step is moving 12 the picking unit, holding the cardboard blank 80 in a position adjacent to a folding unit 41. Then, there is a step of transferring 13 the cardboard blank 80 from the picking unit 42 to the folding unit 41, thereby folding 14 the side areas 82 of the cardboard blank 80 to form long lid sides, with the folding unit 41 acting as an anvil and the picking unit 42 acting as a stamp. In this first folding of the lid's long sides, the angle between the lid's long sides 82 and the lid's main area 81, is below 90°, such that the lid is slightly open in order to more easily place it over the primary packages 92. Finally, there is a step of forming 15 short edges of the cardboard blank 80 to short lid sides by folding them and holding them together, to form the lid for the secondary package.

The step of forming 15 the short edges of the cardboard blank 80 may comprise a first step of folding 15a side flaps 83 towards each other, so that they are substantially perpendicular, at a 90° angle, in relation to the long side areas 82, to form short sides while at the same time bringing the lid's long sides 82 to a 90° angle to the lid's main area 81. Next, there may be a second step of applying 15b an adhesive to the surface of the side flaps 83 facing away from the primary packages. Finally, there may be a step of folding 15c a side cover 84 over the side flaps 83.

The side flaps 83 of the lid blank are folded against the primary packages 92 when the folding fingers 51c, pivoting around the pivot axis from an open position (as shown in FIG. 9B) to a closed position, are moved 90° towards the center of the folding space (as shown in FIG. 9A). Here, the side flaps 83 are folded against the primary packages so that they are substantially perpendicular, at a 90° angle, in relation to the long side areas 82, to form short sides.

The folding slide 51b has flat sections 51d that push side areas of the lid 82 against the packages 92. The folding slide 51b is moved from the inoperative position to the operative position, so that it emerges on each side of the folding bracket 51a, in order to push side areas of the lid 82 against the primary packages 92, see top left in FIG. 6 where the folding bracket 51a is shown as a hatched area surrounded by the folding slide 51b. The folding bracket 51a hence loses contact with the blank at this point, but it is held in place by the folding slide 51b, specifically the flat sections 51d, in its operative position. The flat sections 51d of the folding slide 51b lie in a plane that is perpendicular to the direction of movement of the folding slide 51b, and will push the side areas of the lid 82 to a 90 degree angle in relation to the lid's main area 81.

According to this invention, the glue is a melt glue applied by a glue dispenser (not shown), positioned to dispense a proper amount of glue on the side flaps 83 to achieve adhesion between the long side areas 82 of the lid. However, any kind of adhesive, such as glue, applied in any kind of suitable way, may be used in the invention. All this will be easily appreciated by a person skilled in the art.

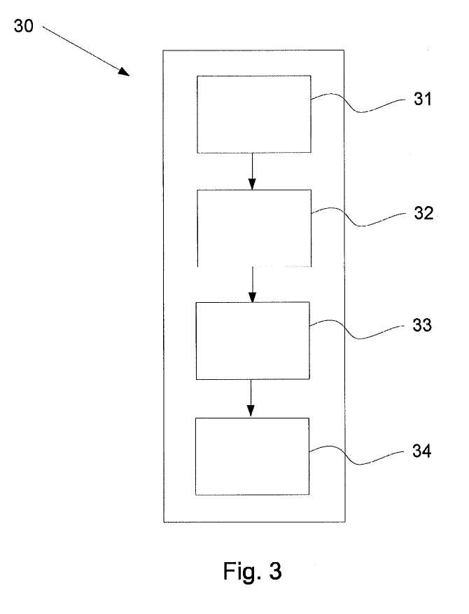

Thus, in an embodiment of the invention, there is provided a method according to FIG. 3, for producing a lid for a secondary package encasing primary packages 92.

Although the present invention has been described above with reference to specific embodiments, it is not intended to be limited to the specific form set forth herein. Rather, the invention is limited only by the accompanying claims and, other embodiments than the specific above are equally possible within the scope of these appended claims.

In the claims, the term “comprises/comprising” does not exclude the presence of other elements or steps. Furthermore, although individually listed, a plurality of means, elements or method steps may be implemented by e.g. a single unit. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A method for producing a lid for a secondary package, said secondary package intended to encase primary packages, wherein said method comprises folding the lid from a cardboard blank, comprising: side areas along a length of the blank, and the method comprises
picking the cardboard blank from a magazine with a picking unit;
moving the picking unit, holding the cardboard blank to a position adjacent to a folding unit;
transferring the cardboard blank from the picking unit to the folding unit, whereby the folding unit acts as an anvil and the picking unit acts as a stamp; thereby
folding the side areas of the cardboard blank to form long lid sides; and
forming short edges of the cardboard blank to short lid sides by folding them and holding them together, to form the lid for the secondary package.

2. The method according to claim 1, wherein the forming of the short edges of the cardboard blank comprises:
folding side flaps towards each other, so that they are substantially perpendicular to the long side areas, to form short sides;
applying an adhesive to the surface of the side flaps facing away from the primary packages; and
folding a side cover over the side flaps.

3. The method according to claim 1, wherein the folding of the side areas of the cardboard blank to form long lid sides comprises a first and a second folding, a first folding in which the long lid sides are folded less than 90 degrees, a second folding in which said long sides are folded to a 90 degree angle relative to a main area of the cardboard blank, a third folding of the side flaps, to form short sides of the lid, and with synchronization of the second and third folding through a synchronization means using the movement of the second folding as the driving force.

4. An apparatus for producing a secondary package, said secondary package encasing primary packages, said apparatus comprising a lid folder, comprising a folding unit and a picking unit, wherein both the folding unit and the picking unit comprises holding means positioned in relation to the folding unit so that, in use, a cardboard blank is folded between the picking unit and the folding unit, with the folding unit acting as an anvil and the picking unit acting as a stamp, when the cardboard blank is transferred from the holding means of the picking unit to the holding means of the folding unit.

5. The apparatus according to claim 4, wherein the folding unit comprises folding brackets facing the picking unit, when the picking unit is in the position adjacent the folding unit.

6. The apparatus according to claim 4, wherein the distance between a particular holding means of the picking unit and the respective folding bracket located closest to the holding means is below 20 mm.

7. The apparatus according to claim 4, wherein folding assemblies, comprising folding means for folding the cardboard blank, are mounted on a folding carrier.

8. The apparatus according to claim 7, wherein the folding carrier comprises: holding means of the folding unit.

9. The apparatus according to claim 7, wherein at least one of the folding carriers is adjustably mounted to a track.

10. The apparatus according to claim 4, wherein the holding means are suction cups.

11. The apparatus according to claim 4, wherein the folding unit comprises a vertical transport arm, attached to a number of hanging rods, which are aligned substantially perpendicular to the central axis of the vertical transport arm, and wherein the hanging rods penetrate two side plates, whereof at least one side plate is slidable along the length of the hanging rods, and which side plate is releasably fixated in an optional position on the hanging rods.
